(19) United States
(12) Patent Application Publication
(10) Pub. No.: US 2016/0111778 A1
(43) Pub. Date: Apr. 21, 2016

(54) Multiple-Input Multiple-Output Antenna System and Apparatus

(71) Applicant: VERTU CORPORATION LIMITED, Fleet, Hampshire (GB)

(72) Inventors: Dawei Zhou, Woking (GB); Andy Hannigan, Thatcham (GB); Zidong Liu, Poole (GB)

(21) Appl. No.: 14/781,679

(22) PCT Filed: Apr. 2, 2013
(86) PCT No.: PCT/EP2013/056866

§ 371 Date: Dec. 2, 2015

(51) Int. Cl. H01Q 1/52; H01Q 21/30; H01Q 21/28; H01Q 1/12

(52) U.S. Cl. CPC H01Q 1/521; H01Q 1/12; H01Q 1/526; H01Q 21/30; H01Q 21/28

(57) ABSTRACT

A multiple-input multiple-output (MIMO) antenna system includes a first elongated antenna connected to a first feed point, comprising a radiator configured to resonate in at least one frequency band; a second elongated antenna connected to a second feed point, comprising a radiator configured to resonate in at least one frequency band; a support element, whereto the first and the second elongated antenna being attached parallel with a first distance. The antenna system further includes an elongated conductive element connected to a ground and attached to the support element, the elongated conductive element configured to reduce coupling between the first and the second radiator.

### TECHNICAL FIELD

The invention relates to antenna structures, and particularly to multiple-input multiple-output (MIMO) internal antennas used in mobile apparatuses.

### BACKGROUND ART

Portable apparatuses, such as mobile phones, tablets and personal computers have ever increasing demand for a high-speed data access. Furthermore, an antenna system of the apparatus may be arranged to operate in a plurality of different operational radio frequency bands and via a plurality of different protocols. For example, the different frequency bands and protocols may include (but are not limited to) Long Term Evolution (LTE) 700 (US) (698.0-716.0 MHz, 728.0-746.0 MHz), LTE 1500 (Japan) (1427.9-1452.9 MHz, 1475.9-1500.9 MHz), LTE 2600 (Europe) (2500-2570 MHz, 2620-2690 MHz), amplitude modulation (AM) radio (0.535-1.705 MHz); frequency modulation (FM) radio (76-108 MHz); Bluetooth (2400-2483.5 MHz); wireless local area network (WLAN) (2400-2483.5 MHz); helical local area network (HLAN) (5150-5850 MHz); global positioning system (GPS) (1570.42-1580.42 MHz); US—Global system for mobile communications (US-GSM) 850 (824-894 MHz); European global system for mobile communications (EGSM) 900 (880-960 MHz); European wideband code division multiple access (EU-WCDMA) 900 (880-960 MHz); personal communications network (PCN/DCS) 1800 (1710-1880 MHz); US wideband code division multiple access (US-WCDMA) 1900 (1850-1990 MHz); wideband code division multiple access (WCDMA) 2100 (Tx: 1920-1980 MHz Rx: 2110-2180 MHz); personal communications service (PCS) 1900 (1850-1990 MHz); ultra wideband (UWB) Lower (3100-4900 MHz); UWB Upper (6000-10600 MHz); digital video broadcasting—handheld (DVB-H) (470-702 MHz); DVB-H US (1670-1675 MHz); digital radio mondiale (DRM) (0.15-30 MHz); worldwide interoperability for microwave access (WiMax) (2300-2400 MHz, 2305-2360 MHz, 2496-2690 MHz, 3300-3400 MHz, 3400-3800 MHz, 5250-5875 MHz); digital audio broadcasting (DAB) (174.928-239.2 MHz, 1452.96-1490.62 MHz); radio frequency identification low frequency (RFID LF) (0.125-0.134 MHz); radio frequency identification high frequency (RFID HF) (13.56-13.56 MHz); radio frequency identification ultra-high frequency (RFID UHF) (433 MHz, 865-956 MHz, 2450 MHz).

With the ever increasing demand on the high-speed data access on the mobile devices, multiple-input multiple-output (MIMO) antennas on the devices have been adapted and used in order to be able to provide the required data rate. For a well-designed multiple-input multiple-output (MIMO) antenna system, low mutual coupling and uncorrelated antenna far field patterns between antennas are desired. If the multiple-input multiple-output (MIMO) antenna is poorly designed, the mutual coupling of the antennas becomes high and also the individual antenna efficiency becomes lower. Furthermore, antenna's envelope correlation coefficient (ECC) would also become considerably high. As a result, the channel capacity (date rates) of mobile communication systems will be significantly degraded and benefit of using multiple-input multiple-output (MIMO) antennas may be lost.

Today's mobile apparatuses prefer reduced sizes for components, especially for components and elements not relating to user interface of the apparatus. Due to the size constrain of a typical smart phone, for example, antenna diversity techniques should be employed in order to realize a two-element multiple-input multiple-output (MIMO) antenna system with an acceptable coupling behavior. In general, three types of antenna diversity techniques have been widely used in mobile communications, including spatial diversity, polarization diversity and pattern diversity. The spatial diversity requires e.g. two antennas separated with a distance of at least λ/2 (λ is a wavelength in free space). For the polarization diversity, e.g. two antennas may be placed closed to each other, but each antenna features different polarization. For the pattern diversity, e.g. two antennas can also be closely placed between each other, but each antenna possesses directional antenna radiation pattern and does not overlap each other's pattern.

If the design assumption is to use top and bottom multiple-input multiple-output (MIMO) antenna configuration, a mobile apparatus with around 135 mm in length will be unlikely to achieve a good spatial diversity with such separation distance since the half wavelength at a LTE 700 MHz frequency band is about 200 mm. The multiple-input multiple-output (MIMO) antenna performance degrades and may not meet design requirements. Thus, an antenna system and an apparatus are needed to provide multiple-input multiple-output (MIMO) functionality for antenna diversity that is operable as an internal antenna of a mobile apparatus with an improved performance.

### SUMMARY

According to a first example aspect of the invention there is provided a multiple-input multiple-output (MIMO) antenna system comprising:
a first elongated antenna connected to a first feed point, comprising a radiator configured to resonate in at least one frequency band;
a second elongated antenna connected to a second feed point, comprising a radiator configured to resonate in at least one frequency band;
a support element, whereto the first and the second elongated antenna being attached parallel with a first distance; and
an elongated conductive element connected to a ground and attached to the support element, the elongated conductive element configured to reduce coupling between the first and the second radiator.

In an embodiment, the support element comprises a circuit board, a body part or a cover part of an apparatus.

In an embodiment, the elongated conductive element is configured to reduce correlation between the first and the second radiator.

In an embodiment, the elongated conductive element is perpendicular to the first and the second elongated antenna.

In an embodiment, the elongated conductive element is located with a second distance perpendicular to the first elongated antenna, and the second distance being smaller than the first distance.

In an embodiment, the first and the second feed point are located in a first end of the first and the second elongated antenna, respectively.

In an embodiment, the first and the second elongated antenna are attached on a first end of the support element.

In an embodiment, the first and the second elongated antenna being attached on a first end and on the second end of the support element, respectively.

In an embodiment, the elongated conductive element is located closer to a second end of the first elongated antenna.

In an embodiment, at least two elongated conductive elements are located with a second distance, the second distance being smaller that the first distance.

In an embodiment, the at least two elongated conductive elements located perpendicular to the first elongated antenna,

In an embodiment, the elongated conductive element comprises a rail made of a metal.

In an embodiment, the elongated conductive element comprising a conductive painting located on the supportive element.

According to a second example aspect of the invention there is provided an apparatus comprising,
a multiple-input multiple-output (MIMO) antenna system comprising:
   a first elongated antenna connected to a first feed point, comprising a radiator configured to resonate in at least one frequency band;
   a second elongated antenna connected to a second feed point, comprising a radiator configured to resonate in at least one frequency band;
   a support element, whereto the first and the second elongated antenna being attached parallel with a first distance; and
   an elongated conductive element connected to a ground and attached to a support element, the elongated conductive element configured to reduce coupling between the first and the second radiator.

In an embodiment, the support element comprises at least one of a circuit board, a body part and a cover part of the apparatus.

In an embodiment, the support element comprises a circuit board of the apparatus, and the first and the second elongated antenna being attached parallel with a first distance on the circuit board.

In an embodiment, the elongated conductive element is attached to the circuit board of the apparatus.

In an embodiment, the support element comprises a cover part of the apparatus, and the elongated conductive element being attached to the cover part of the apparatus.

In an embodiment, the support element comprises a body part of the apparatus, and the elongated conductive element being attached to the body part.

According to a third example aspect of the invention there is provided a method for providing a multiple-input multiple-output (MIMO) antenna system, the method comprising:
connecting a first elongated antenna to a first feed point, the first elongated antenna comprising a radiator configured to resonate in at least one frequency band;
connecting a second elongated antenna to a second feed point, the second elongated antenna comprising a radiator configured to resonate in at least one frequency band;
attaching the first and the second elongated antenna parallel with a first distance to a support element;
connecting an elongated conductive element to a ground; and
attaching the elongated conductive element to the support element, the elongated conductive element configured to reduce coupling between the first and the second radiator.

Different non-binding example aspects and embodiments of the present invention have been illustrated in the foregoing. The above embodiments are used merely to explain selected aspects or steps that may be utilized in implementations of the present invention. Some embodiments may be presented only with reference to certain example aspects of the invention. It should be appreciated that corresponding embodiments may apply to other example aspects as well.

### BRIEF DESCRIPTION OF THE DRAWINGS

The invention will be described, by way of example only, with reference to the accompanying drawings, in which:

FIG. 1 shows some details of an antenna system in which various embodiments of the invention may be applied;

FIG. 2 shows some details of another antenna system in which various embodiments of the invention may be applied;

FIG. 3 presents a schematic view of an antenna system with four grounded conductive elements for an apparatus, in which various embodiments of the invention may be applied;

FIG. 4 presents a schematic view of an antenna system with two grounded conductive elements for an apparatus, in which various embodiments of the invention may be applied;

FIG. 5 presents a schematic view of another antenna system with two grounded conductive elements for an apparatus, in which various embodiments of the invention may be applied;

FIG. 6 presents a schematic view of another antenna system with two grounded conductive elements for an apparatus, in which various embodiments of the invention may be applied;

FIG. 7 presents a schematic view of an antenna system with one grounded conductive element for an apparatus, in which various embodiments of the invention may be applied;

FIG. 8 presents a schematic view of an apparatus in which various embodiments of the invention may be applied;

FIG. 9 presents an example block diagram of an apparatus in which various embodiments of the invention may be applied;

FIG. 10 shows operations in an apparatus in accordance with an example embodiment of the invention;

FIGS. 11a-c show some details of an antenna system in which various embodiments of the invention may be applied.

### DETAILED DESCRIPTION

In the following description, like numbers denote like elements.

For mobile apparatus antennas, the directional radiation pattern may not be preferred due to the fact that received signals may arrive at any angles due to reflections. With the recently launched Long Term Evolution (LTE) services, the apparatus is required to operate at low frequency spectrum from 700 MHz band that corresponds to longer wavelengths to be received. Spatial antenna diversity may be used but due to small dimensions of mobile apparatuses performance is expected to be poor. Thus an improved antenna system is needed.

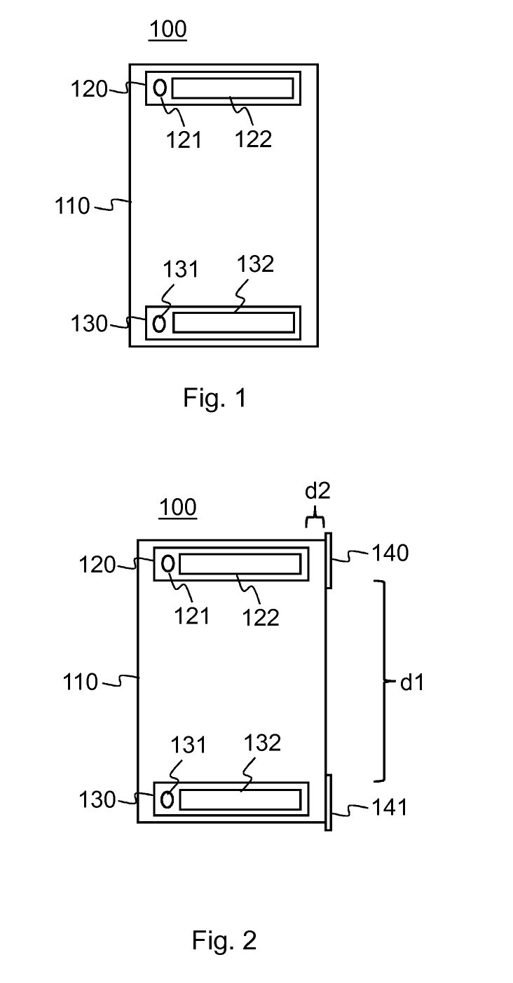

FIG. 1 shows some details of an antenna system 100 in which various embodiments of the invention may be applied.

In an embodiment, a multiple-input multiple-output (MIMO) antenna system 100 comprises a support element 110, such as a printed circuit board (PCB), a body part or a cover part of an apparatus. The antenna system 100 further comprises a first elongated antenna 120 connected to a first feed point 121, comprising a radiator 122 configured to resonate in at least one frequency band. The antenna 120 may comprise several contact points and radiators, and their shapes may be different than shown in FIG. 1.

The antenna system 100 further comprises a second elongated antenna 130 connected to a second feed point 131, comprising a radiator 132 configured to resonate in at least one frequency band. The frequency band of the second antenna may be the same as for the first antenna in at least one band or a different band.

The first and the second antenna 120, 130 are attached parallel to a support element 110 over a certain distance. In the embodiment of FIG. 1, the first antenna 120 is located in the upper end of the support element 110 and the second antenna is located in the lower end of the support element 110. Alternatively, the left and right end of the support element 110 may be used. When placing the antennas 120, 130 as far away from each other as possible in the support element 110, spatial diversity may be improved.

FIG. 2 shows some details of an antenna system 100 in which various embodiments of the invention may be applied.

In an embodiment, a multiple-input multiple-output (MIMO) antenna system 100 comprises a support element 110, such as a printed circuit board (PCB), a body part or a cover part of an apparatus. The antenna system 100 further comprises a first elongated antenna 120 connected to a first feed point 121, comprising a radiator 122 configured to resonate in at least one frequency band. The antenna 120 may comprise several contact points and radiators, and their shapes may be different than shown in FIG. 2.

The antenna system 100 further comprises a second elongated antenna 130 connected to a second feed point 131, comprising a radiator 132 configured to resonate in at least one frequency band. The frequency band of the second antenna may be the same as for the first antenna in at least one band or a different band.

The first and the second antenna 120, 130 are attached parallel to a support element 110 over a first distance d1. In the embodiment of FIG. 2, the first antenna 120 is located in the upper end of the support element 110 and the second antenna is located in the lower end of the support element 110. Alternatively, the left and right end of the support element 110 may be used. When placing the antennas 120, 130 as far away from each other as possible in the support element 110, spatial diversity may be improved.

An elongated conductive element 140, 141 is connected to a ground level and attached to the support element 110. The elongated conductive element 140, 141 may be perpendicular to the first and the second elongated antenna 120, 130. The elongated conductive element 140, 141 is configured to reduce coupling and/or correlation between the first and the second radiator 122, 132 and thus improve the operation performance of the antennas. The support element 110 may comprise a circuit board, a body part or a cover part of an apparatus. The antenna system 100 may comprise a plurality of support elements 110. For example, antennas 120, 130 may be attached to a printed circuit board of the apparatus and the conductive element may be attached to a cover part of the apparatus.

In an embodiment, the elongated conductive element 140, 141 of the multiple-input multiple-output (MIMO) antenna system 100 may be located with a second distance d2 to the radiator 122 of the first elongated antenna 140, the second distance d2 being smaller than the first distance d1.

In an embodiment, a plurality of elongated conductive elements 140, 141 may be comprised in the system 100. In FIG. 2, the second distance d2 may be similar for both conductive elements 140, 141 and radiators 122, 132 of antennas 120, 130.

In an embodiment, the first and the second feed point 121, 131 of the first and the second antenna 120, 130, may be located in a first end of the first and the second elongated antenna, respectively. The elongated conductive element 140, 141 may be located closer to a second end of the first elongated antenna 120, 130.

In an embodiment, the elongated conductive element 140, 141 may comprise a rail made of a metal.

In an embodiment, at least one metal side rail 140, 141 is used perpendicularly placed along a long lateral of a printed circuit board (PCB) 110 for improving the multiple-input multiple-output (MIMO) antenna 120, 130 performance for mobile apparatuses with a top/bottom arranged MIMO antenna configuration. It has proven that such embodiment has successfully achieved the desired goal, with effective improvement on the antenna 120, 130 mutual coupling and on the envelope correlation coefficient (ECC) compared to the similar MIMO antenna configuration without having any metal rails 140, 141.

Antenna radiator type may be a quarter wavelength radiator, e.g. monopole, printed inverted F antenna (PIFA), inverted F antenna (IFA), for example.

Two antennas 120, 130 may be placed at the top and bottom end of the apparatus printed circuit board (PCB) 110 respectively. Feeding points 121, 131 for each antenna 120, 130 may be located on the same side of the apparatus printed circuit board (PCB) 110. The antenna radiators 122, 132 may be on ground, off ground or partially on ground.

In an embodiment of FIG. 1 or 2, electric field (E-field) direction of both antennas 120, 130 is generally perpendicular towards an apparatus printed circuit board (PCB) 110. Thus, the direction of the induced surface current from both antennas 120, 130 is essentially parallel to the surface of the apparatus PCB 110. The subsequently induced surface current from one antenna 120, 130 can be coupled to the other antenna 120, 130 through the apparatus PCB 110. As a result, the two antennas 120, 130 with top/bottom arrangement may suffer a high mutual coupling and also high antenna correlation if separation distance of the two spatially placed antennas 120, 130 is less than λ/2 of the electromagnetic wave length the antenna 120, 130 is operating. Small mobile apparatuses may face the problem of the distance being limited.

At least one metal rail 140, 141 may be vertically placed in different locations in the antenna system 100. The metal rails 140, 141 are grounded to the apparatus ground level. The ground level of the apparatus printed circuit board (PCB) 110 may be used, the same ground that may be used for the antennas 120, 130. The behavior of such metal rail arrangement with MIMO antennas as in FIG. 2 can effectively act as changing the direction of the electrical field (E-field) from both antennas 120, 130 compared to the electric field (E-field) direction from generally vertical direction in the solution of FIG. 1. The decomposition component of the electric field (E-field) in vertical direction towards the phone printed circuit board (PCB) 110 should thus become weaker. The surface current coupled from one antenna 120, 130 to the other antenna 120, 130 is therefore reduced. As a result, the mutual coupling between the two spatially closely placed antennas 120, 130 can be improved. The antenna correlation (ECC figure) can also be reduced.

In an embodiment, the effectiveness of at least one added metal rail 140, 141 depends on the distance d2 between the antenna radiator's open end and the metal rail 140, 141. Such arrangement is more effective if the antenna radiator track 122, 132 open end is close to the metal rail 140, 141 since the maximum electric field (E-field) is usually concentrated at the open end of the antenna 120, 130.

A plurality of different embodiments exists for the elongated conductive element 140, 141, such as the metal rail.

In an embodiment, two antennas 120, 130 may be located at one end of the phone PCB 110, either on top or at bottom. The first antenna 120 may resonate in at least one frequency band; the second antenna 130 may resonate in at least one frequency band. The frequency band of the first antenna 120 may be the same as or close to the second antenna 130 in at least one frequency band. When the grounded elongated conductive element 140, 141 (e.g. metal rails) is attached to the support element 110 (e.g. the PCB), the elongated conductive element 140, 141 is configured to reduce coupling and/or correlation between the first and the second radiators 122, 132.

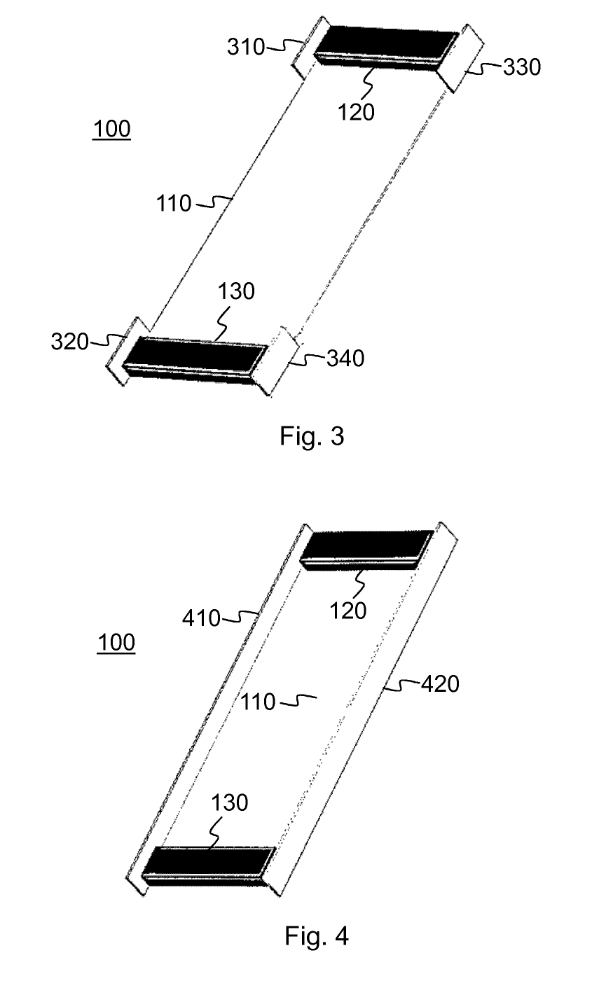

FIG. 3 presents a schematic view of an antenna system 100 with four grounded conductive elements 310-340 for an apparatus, in which various embodiments of the invention may be applied.

The antenna system 100 comprises two multiple-input multiple-output (MIMO) antennas 120, 130 that are placed to essentially top and bottom end of a support element 110, respectively. The support element 110 may comprise a printed circuit board (PCB), a body part or a cover part of an apparatus, for example. Using four grounded conductive elements 310-340, such as two pairs of metal rails, provides conductive elements for both ends of top and bottom antennas 120, 130. Length and width of each element 310-340, such as the metal rail, can be decided based on the volume of each antenna 120, 130.

FIG. 4 presents a schematic view of an antenna system 100 with two grounded conductive elements 410-420 for an apparatus, in which various embodiments of the invention may be applied.

The antenna system 100 comprises two multiple-input multiple-output (MIMO) antennas 120, 130 that are placed to essentially top and bottom end of a support element 110, respectively. The support element 110 may comprise a printed circuit board (PCB), a body part or a cover part of an apparatus, for example. Using two grounded conductive elements 410-420, such a pairs of metal rails, provides conductive elements for both ends of top and bottom antennas 120, 130. Length and width of each element 410-420, such as the metal rail, can be decided based on the volume of each antenna 120, 130. The metal rails 410, 420 may further be configured to protect components, also other than the antennas 120, 130, on the printed circuit board (PCB) while extending on the side of the board on the area between the antennas 120, 130. The metal rails 410, 420 may operate as a body part for an apparatus in an embodiment as in FIG. 4 with two longer rails. Furthermore, in case the cover part of the apparatus comprises metal, the cover part may operate as the conductive element 410, 420.

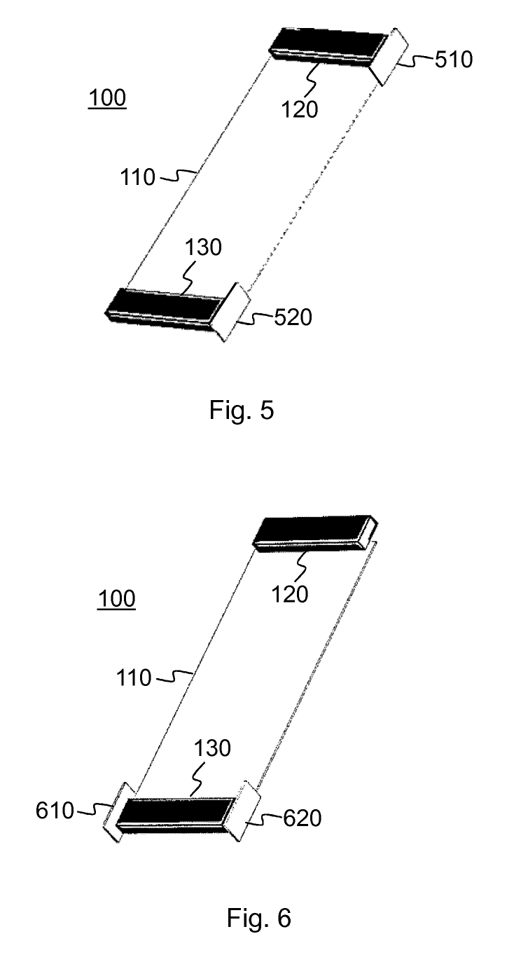

FIG. 5 presents a schematic view of another antenna system 100 with two grounded conductive elements 510, 520 for an apparatus, in which various embodiments of the invention may be applied.

The antenna system 100 comprises two multiple-input multiple-output (MIMO) antennas 120, 130 that are placed to essentially top and bottom end of a support element 110, respectively. The support element 110 may comprise a printed circuit board (PCB), a body part or a cover part of an apparatus, for example. Using two grounded conductive elements 510-520, such as two metal rails, provides conductive elements for one end of top and bottom antennas 120, 130. Length and width of each element 510-520, such as the metal rail, can be decided based on the volume of each antenna 120, 130. For example, two metal rails 510, 520 may be used on the same side for the top and bottom antennas 120, 130. The metal rails should be placed to the side where the antenna radiator's open end is close to.

In this embodiment, feed points of the antennas 120, 130 may be located in the opposite end of the antennas to the conductive elements 510, 520. Such embodiment may improve multiple-input multiple-output (MIMO) antenna 120, 130 performance but keep the apparatus manufacturing easier and material costs lower.

FIG. 6 presents a schematic view of another antenna system 100 with two grounded conductive elements 610, 620 for an apparatus, in which various embodiments of the invention may be applied.

The antenna system 100 comprises two multiple-input multiple-output (MIMO) antennas 120, 130 that are placed to essentially top and bottom end of a support element 110, respectively. The support element 110 may comprise a printed circuit board (PCB), a body part or a cover part of an apparatus, for example. Using two grounded conductive elements 610-620, such as two metal rails, provides conductive elements for both ends of a top or a bottom antenna 120, 130. Other antenna 120, 130 does not have conductive elements. Length and width of each element 610-620, such as the metal rail, can be decided based on the volume of each antenna 120, 130. For example, two metal rails 610, 620 may be used on both sides of the top or the bottom antenna 120, 130.

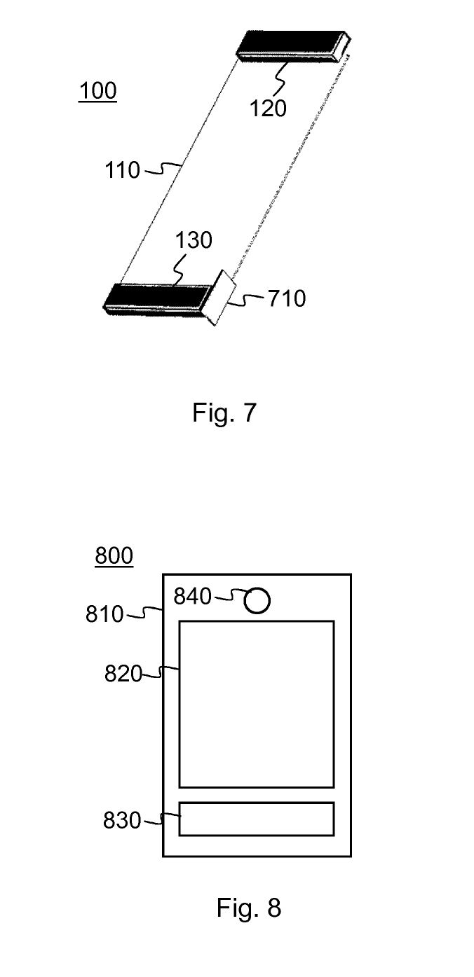

FIG. 7 presents a schematic view of an antenna system 100 with one grounded conductive element 710 for an apparatus, in which various embodiments of the invention may be applied.

The antenna system 100 comprises two multiple-input multiple-output (MIMO) antennas 120, 130 that are placed to essentially top and bottom end of a support element 110, respectively. The support element 110 may comprise a printed circuit board (PCB), a body part or a cover part of an apparatus, for example. Using a single grounded conductive element 710, such as a metal rail, provides conductive element for one end of a top or a bottom antenna 120, 130. Other antenna 120, 130 does not have conductive elements. Length and width of the element 710, such as the metal rail, can be decided based on the volume of each antenna 120, 130. The conductive element 710, such as the metal rail, may also extend to the top part of the support element 110 to provide conductive element to other antenna 120, 130, correspondingly to FIG. 4 element 420.

In this embodiment, feed point of the antennas 120, 130 may be located in the opposite end of the antennas to the conductive elements 710.

Embodiments improve multiple-input multiple-output (MIMO) antenna performance including mutual coupling and antenna correlation of a top/bottom MIMO antenna configuration for mobile apparatuses compared to the known solutions of same antenna topology.

Mobile apparatuses comprising metal covers provide further advantages. Part of the apparatus body or cover part may be used as the desired conductive element. For example, the apparatus side walls may be implemented using a conductive material, such as metal. Such side walls may be configured so that the side walls are located close to the multiple-input multiple-output (MIMO) antennas inside the apparatus to provide the desired antenna performance. Thus no additional components are needed and the antenna performance of the apparatus is improved. Further the outlook and the design of the apparatus are not compromised.

In an embodiment, polarization diversity technique may be used, where antennas are placed so that at least one antenna is located at the side and the other at the bottom of the printed circuit board (PCB) of the apparatus. For example, a first and the second antenna 120, 130 may be located in the top and the bottom of the PCB 110 as in FIG. 7 for providing spatial diversity and a third antenna on the left or the right edge of the PCB 110 for providing polarization diversity. At least one conductive element 710 may be placed close to the end of the first and the second antenna 120, 130 that is further away from the third antenna. For example, in case of FIG. 7 elements, the third antenna may be placed to the left edge of the PCB 110 and the at least one conductive element may be placed to the right edge of the PCB 110.

FIG. 8 presents a schematic view of an apparatus 800 in which various embodiments of the invention may be applied.

In an embodiment, the apparatus 800 may comprise a mobile phone, a smart phone, a tablet, a laptop or any other portable apparatus. The apparatus comprises at least one cover part 810 for providing protection to the components of the apparatus 800 and creating desired outlook and outer design for the apparatus 800. The cover part 810 may comprise several separate cover parts, such as front and rear covers and even a side frame. The apparatus 800 further comprises user interface 820, 830 comprising at least one display 820. The display 820 may be a touch-sensitive display for detecting user gestures and providing feedback for the apparatus 800. The apparatus 800 may also comprise a user input device 830, such as a keypad or a touchpad, for example. Furthermore, the apparatus 800 may comprise a camera 840. No matter the described elements 810, 820, 830, 840 are shown on the same side of the apparatus 800, they can be located on any side of the apparatus 800.

In an embodiment, at least one of the apparatus elements 810, 820, 830, 840 comprises a conductive element, such as metal rail or sheet, for example. The cover part 810 may comprise a metallic element, such as metal coating, to provide good-looking, strong and scratch resistant surface for the apparatus. The display 820 may comprise a metallic element, such as a display frame or layer, to provide strong body for the display. The user input device may comprise a metallic element, similarly as the display, in case of a touchpad, and similarly as the cover part for the keypad frame in case of a traditional keypad. The camera 840 may comprise an optical element, such as protective cover or body, for example.

The cover part 810 may comprise a casing for a portable communication device for receiving an engine or the antenna system 100 of FIGS. 1-7 for operation of the device, the casing comprising: a surface layer as a metallic conductive element, mounted on a defined area of a housing defining, along with the surface layer, at least one layer for the housing; and means for engaging the exposed areas of the substrate with the housing. The metallic layer may also be adhered to the substrate. The adherent may be a UV curing adhesive, for example.

In embodiments of the invention the metallic layer may provide an operating face of the device. This gives a design engineer far greater freedom to design a device with a desirable appearance. The operating face may be provided with a user input element 830, for example a key, or an array of such elements. The casing may be a conventional one part casing or a clam shell, or other two or more part arrangement, where the user input elements 830 or keys may be located on a different face to a display 820.

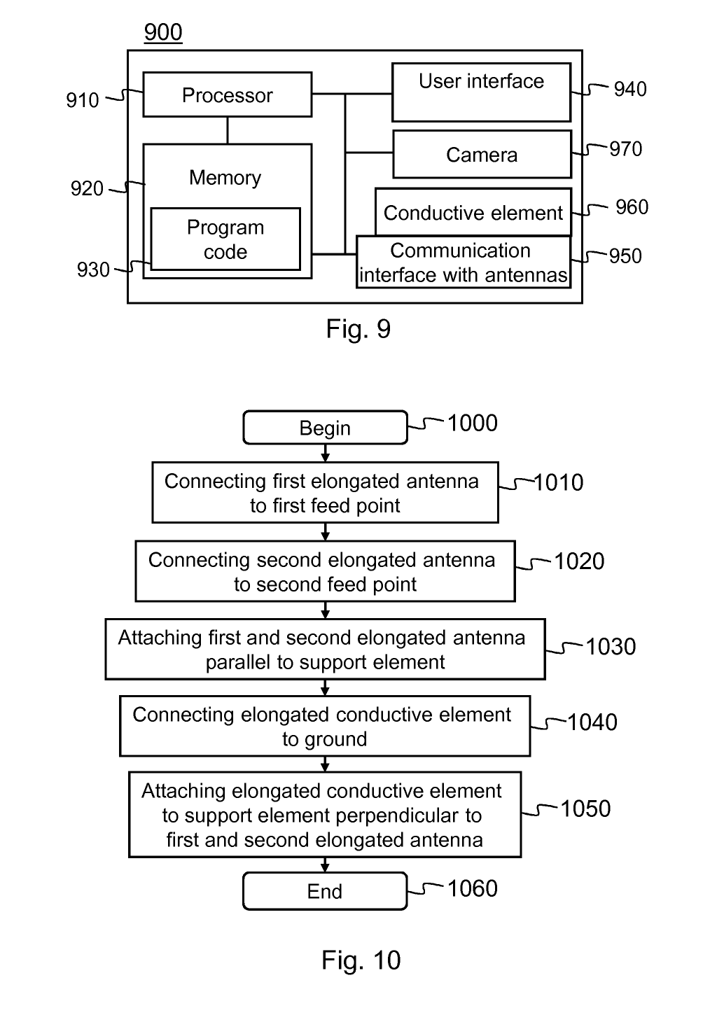

FIG. 9 presents an example block diagram of an apparatus 900 in which various embodiments of the invention may be applied. The apparatus 900 may be a user equipment (UE), user device or apparatus, such as a mobile terminal, a smart phone, a personal digital assistant (PDA), a laptop, a tablet or other communication device.

The general structure of the apparatus 900 comprises a user interface 940, a communication interface 950 including at least two elongated antennas attached parallel, a processor 910, a camera 970, and a memory 920 coupled to the processor 910. The apparatus 900 further comprises software 930 stored in the memory 920 and operable to be loaded into and executed in the processor 910. The software 930 may comprise one or more software modules and can be in the form of a computer program product. The apparatus 900 further comprises a conductive element 960 attached perpendicular to the antennas to reduce coupling between a first and a second radiator of the antennas. The conductive element 960 may also be integrated to another element of the apparatus 900, for example to a cover part, a body part, a circuit board, the user interface 940, or the camera 970.

The processor 910 may be, e.g. a central processing unit (CPU), a microprocessor, a digital signal processor (DSP), a graphics processing unit, or the like. FIG. 9 shows one processor 910, but the apparatus 900 may comprise a plurality of processors.

The memory 920 may be for example a non-volatile or a volatile memory, such as a read-only memory (ROM), a programmable read-only memory (PROM), erasable programmable read-only memory (EPROM), a random-access memory (RAM), a flash memory, a data disk, an optical storage, a magnetic storage, a smart card, or the like. The apparatus 900 may comprise a plurality of memories. The memory 920 may be constructed as a part of the apparatus 900 or it may be inserted into a slot, port, or the like of the apparatus 900 by a user. The memory 920 may serve the sole purpose of storing data, or it may be constructed as a part of an apparatus serving other purposes, such as processing data.

The user interface 940 may comprise circuitry for receiving input from a user of the apparatus 900, e.g., via a keyboard, graphical user interface shown on the display of the user apparatus 900, speech recognition circuitry, or an accessory device, such as a headset, and for providing output to the user via, e.g., a graphical user interface or a loudspeaker. The display of the user interface 940 may comprise a touch-sensitive display.

The communication interface module 950 implements at least part of radio transmission. The communication interface module 950 may comprise, e.g., a wireless interface module. The wireless interface may comprise such as near field communication (NFC), a WLAN, Bluetooth, infrared (IR), radio frequency identification (RF ID), GSM/GPRS, CDMA, WCDMA, or LTE (Long Term Evolution) radio module. The communication interface module 950 may be integrated into the user apparatus 900, or into an adapter, card or the like that may be inserted into a suitable slot or port of the apparatus 900. The communication interface module 950 may support one radio interface technology or a plurality of technologies. The apparatus 900 may comprise a plurality of communication interface modules 950. The communication interface module 950 comprises a multiple-input multiple-output (MIMO) antenna system comprising a first elongated antenna connected to a first feed point, comprising a radiator configured to resonate in at least one frequency band; and a second elongated antenna connected to a second feed point, comprising a radiator configured to resonate in at least one frequency band.

A skilled person appreciates that in addition to the elements shown in FIG. 9, the apparatus 900 may comprise other elements, such as microphones, displays, as well as additional circuitry such as input/output (I/O) circuitry, memory chips, application-specific integrated circuits (ASIC), processing circuitry for specific purposes such as source coding/decoding circuitry, channel coding/decoding circuitry, ciphering/deciphering circuitry, and the like. Additionally, the apparatus 900 may comprise a disposable or rechargeable battery (not shown) for powering when external power if external power supply is not available.

FIG. 10 shows operations in an apparatus in accordance with an example embodiment of the invention.

In step 1000, a method for providing a multiple-input multiple-output (MIMO) antenna system is started. In step 1010, a first elongated antenna is connected to a first feed point, the first elongated antenna comprising a radiator configured to resonate in at least one frequency band. In step 1020, a second elongated antenna is connected to a second feed point, the second elongated antenna comprising a radiator configured to resonate in at least one frequency band. In step 1030, the first and the second elongated antenna are attached parallel with a first distance to a support element. In step 1040, an elongated conductive element is connected to a ground. In step 1050, the elongated conductive element is attached to the support element, the elongated conductive element configured to reduce coupling and/or correlation between the first and the second radiator. In step 1060, the method ends.

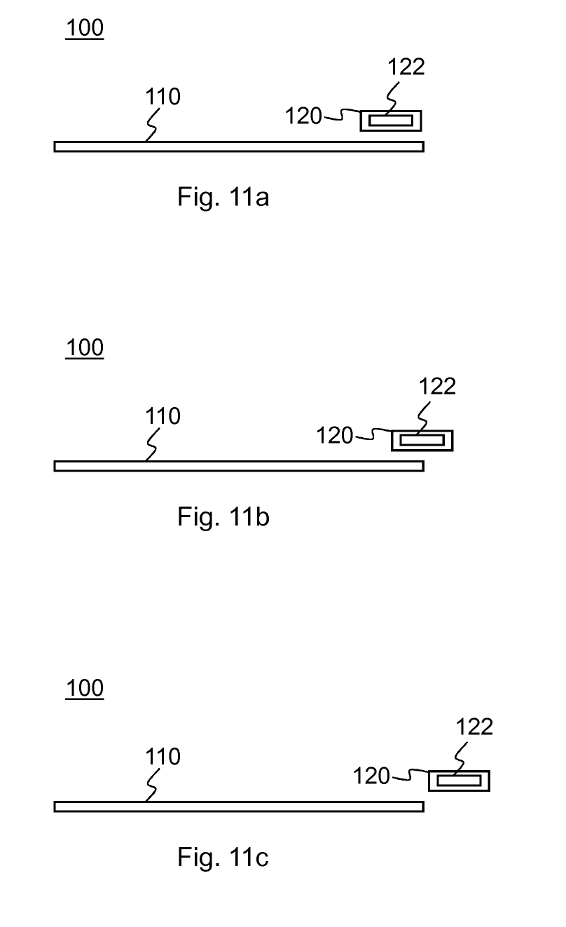

FIGS. 11a-c show some details of an antenna system 100 in which various embodiments of the invention may be applied.

In an embodiment, a multiple-input multiple-output (MIMO) antenna system 100 comprises a support element 110, such as a printed circuit board (PCB), a body part or a cover part of an apparatus. The antenna system 100 further comprises a first elongated antenna 120 connected to a first feed point (not shown), comprising a radiator 122 configured to resonate in at least one frequency band. The antenna 120 may comprise several feed points and radiators, and their shapes may be different than shown in FIGS. 11a-c.

The antenna system 100 further comprises a second elongated antenna (not shown) connected to a second feed point, comprising a radiator configured to resonate in at least one frequency band. The frequency band of the second antenna may be the same as for the first antenna in at least one band or a different band.

By placing the antenna 120 differently on the ground and in view of the ground (e.g. the PCB ground below), the performance of the antenna system 100 may be further improved.

FIG. 11a illustrates relation between grounding provided by the support element 110, such as a printed circuit board (PCB), and the antenna 120, wherein the antenna 120 is fully on the ground.

FIG. 11b illustrates relation between grounding provided by the support element 110, such as a printed circuit board (PCB), and the antenna 120, wherein the antenna 120 is partially on the ground.

FIG. 11c illustrates relation between grounding provided by the support element 110, such as a printed circuit board (PCB), and the antenna 120, wherein the antenna 120 is off the ground.

Various embodiments have been presented. It should be appreciated that in this document, words comprise, include and contain are each used as open-ended expressions with no intended exclusivity.

The foregoing description has provided by way of non-limiting examples of particular implementations and embodiments of the invention a full and informative description of the best mode presently contemplated by the inventors for carrying out the invention. It is however clear to a person skilled in the art that the invention is not restricted to details of the embodiments presented above, but that it can be implemented in other embodiments using equivalent means or in different combinations of embodiments without deviating from the characteristics of the invention.

Furthermore, some of the features of the above-disclosed embodiments of this invention may be used to advantage without the corresponding use of other features. As such, the foregoing description shall be considered as merely illustrative of the principles of the present invention, and not in limitation thereof. Hence, the scope of the invention is only restricted by the appended patent claims.

1. A multiple-input multiple-output (MIMO) antenna system comprising:
a first elongated antenna connected to a first feed point, comprising a radiator configured to resonate in at least one frequency band;
a second elongated antenna connected to a second feed point, comprising a radiator configured to resonate in at least one frequency band;
a support element, whereto the first and the second elongated antenna being attached parallel with a first distance; and
an elongated conductive element connected to a ground and attached to the support element,
the elongated conductive element configured to reduce coupling between the first and the second radiator.

2. The multiple-input multiple-output (MIMO) antenna system of claim 1, wherein the elongated conductive element configured to reduce correlation between the first and the second radiator.

3. The multiple-input multiple-output (MIMO) antenna system of claim 1, wherein the support element comprises a circuit board, a body part or a cover part of an apparatus.

4. The multiple-input multiple-output (MIMO) antenna system of claim 1, wherein the elongated conductive element is perpendicular to the first and the second elongated antenna.

5. The multiple-input multiple-output (MIMO) antenna system of claim 4, wherein the elongated conductive element located with a second distance perpendicular to the first elongated antenna, the second distance being smaller than the first distance.

6. The multiple-input multiple-output (MIMO) antenna system of claim 1, wherein the first and the second feed point located in a first end of the first and the second elongated antenna, respectively.

7. The multiple-input multiple-output (MIMO) antenna system of claim 1, wherein the first and the second elongated antenna being attached on a first end of the support element.

8. The multiple-input multiple-output (MIMO) antenna system of claim 1, wherein the first and the second elongated antenna being attached on a first end and on the second end of the support element, respectively.

9. The multiple-input multiple-output (MIMO) antenna system of claim 6, wherein the elongated conductive element located closer to a second end of the first elongated antenna.

10. The multiple-input multiple-output (MIMO) antenna system of claim 4, wherein at least two elongated conductive elements located with a second distance, the second distance being smaller than the first distance.

11. The multiple-input multiple-output (MIMO) antenna system of claim 10, wherein the at least two elongated conductive elements located perpendicular to the first elongated antenna.

12. The multiple-input multiple-output (MIMO) antenna system of claim 4, wherein the elongated conductive element comprising a rail made of a metal.

13. The multiple-input multiple-output (MIMO) antenna system of claim 4, wherein the elongated conductive element comprising a conductive painting located on the supportive element.

14. An apparatus comprising,
a multiple-input multiple-output (MIMO) antenna system comprising:
a first elongated antenna connected to a first feed point, comprising a radiator configured to resonate in at least one frequency band;
a second elongated antenna connected to a second feed point, comprising a radiator configured to resonate in at least one frequency band;
a support element, whereto the first and the second elongated antenna being attached parallel with a first distance; and
an elongated conductive element connected to a ground and attached to a support element, the elongated conductive element configured to reduce coupling between the first and the second radiator.

15. An apparatus of claim 14, wherein the support element comprises at least one of a circuit board, a body part and a cover part of the apparatus.

16. The apparatus of claim 15, wherein the elongated conductive element is perpendicular to the first and the second elongated antenna.

17. An apparatus of claim 14, wherein the support element comprises a circuit board of the apparatus, and the first and the second elongated antenna being attached parallel with a first distance on the circuit board, wherein the elongated conductive element being attached to the circuit board of the apparatus.

18. (canceled)

19. An apparatus of claim 14, wherein the support element comprises a cover part of the apparatus, and the elongated conductive element being attached to the cover part of the apparatus.

20. An apparatus of claim 14, wherein the support element comprises a body part of the apparatus, and the elongated conductive element being attached to the body part.

21. A method for providing a multiple-input multiple-output (MIMO) antenna system, the method comprising:
connecting a first elongated antenna to a first feed point, the first elongated antenna comprising a radiator configured to resonate in at least one frequency band;
connecting a second elongated antenna to a second feed point, the second elongated antenna comprising a radiator configured to resonate in at least one frequency band;
attaching the first and the second elongated antenna parallel with a first distance to a support element;
connecting an elongated conductive element to a ground; and
attaching the elongated conductive element to the support element, the elongated conductive element configured to reduce coupling between the first and the second radiator.
